(19) United States
(12) Patent Application Publication
(10) Pub. No.: US 2022/0242046 A1
(43) Pub. Date: Aug. 4, 2022

(54) Methods of Forming Orthodontic Appliances

(71) Applicant: Waqas Wahab, Lahore (PK)

(72) Inventor: Waqas Wahab, Lahore (PK)

(21) Appl. No.: 17/548,479

(22) Filed: Dec. 10, 2021

Related U.S. Application Data
(60) Provisional application No. 63/123,583, filed on Dec. 10, 2020.

(51) Int. Cl. B29C 64/386; A61C 9/00; A61C 7/00; B33Y 50/00; B29C 33/38

(52) U.S. Cl. CPC B29C 64/386; A61C 9/0053; A61C 7/08; B33Y 50/00; B29C 33/3835; A61C 7/002

(57) ABSTRACT

Processes for forming orthodontic appliances and other dental inserts comprise scanning a patient's dental arch or a mould of a dental arch such as a traditional plaster mould, to form a digital dental arch file corresponding to the size and position of the patient's dental arch. The digital dental arch file contains data corresponding to a plurality of dimensions corresponding to portions of the patient's dental arch. The disclosed methods include the step of modifying the digital dental arch file to decrease at least one of said dimensions and then utilizing the modified digital dental arch file to form the desired orthodontic appliance and other dental insert.

### RELATED APPLICATION DATA

This application claims the benefit of U.S. Provisional Patent Application Ser. No. 63/123,583, filed Dec. 10, 2020, which is hereby incorporated by reference.

Methods of forming functionally improved, snug fitting orthodontic appliances having a greater surface area contact with the tooth surfaces to deliver optimum orthodontic forces.

### BACKGROUND

The introduction of digital radiology, intraoral and facial scanners, cone-beam computed tomography (CBCT), and additive manufacturing has had a great impact on the efficiency, consistency, accuracy, and predictability of orthodontic treatment outcomes. Traditionally, moulds for transparent orthodontic appliances have been fabricated using a combination of milling and manual processes which are time-consuming and labour-intensive. Appliances fabricated by manual methods commonly use dental plaster as a pouring material to form the “positive” mould. During the drying process, the dental plaster undergoes expansion. Thus the “positive” mould formed of the dental plaster is typically slightly larger than the patient's actual teeth. The appliance formed over such a positive mould is inherently somewhat loose and thus exerts less than optimum orthodontic forces on the patient's teeth.

3D Printing is a process of fabricating a physical object from a three-dimensional digital model (CAD representation) by laying down many successive thin layers of a material. The STL (Standard Triangle Language) is the industry standard file type for 3D Printing that uses a series of triangles to represent the surfaces of a solid model.

3D printing allows orthodontists to directly scan a patient's oral cavity thereby eliminating the uncomfortable impression taking procedure, and those scans are then 3D printed to manufacture clear orthodontic appliances. The key technologies are Stereolithography (SLA) and Material Jetting. In addition to these resin-based processes, HP's powder-based technology and Multi Jet Fusion are also gaining attention. Stereolithography (SLA) utilizes a UV laser that shines through a photo-sensitive liquid resin solidifying some of the liquid into a desired shape. This process creates a set of fully customized moulds used to make dental appliances for treatment in a single step. These molds represent the anticipated/intended positions of patient's teeth as the orthodontic treatment progresses.

3D printing has provided the benefit of more precise control of tooth movement and rapid manufacture of appliances saving both money and time. Other uses of 3D printing include: forming bite splints and night guards using a transparent, biocompatible material. The production of orthodontic appliances is preferably accomplished with clear communication between the dental laboratory and the dentist. 3D printing is a repeatable process ensuring precision and quality, and is less prone to human error. The evolution in transparent orthodontic appliances has led to the incorporation of various auxiliaries in the form of attachments e.g., conventional and optimized, for retention purpose. One concept supports that the attachments should be positioned near the gingival margin and beveled towards the gingival surface to increase retention of transparent orthodontic appliances.

### SUMMARY

For an orthodontic appliance to exert optimal orthodontic forces, it should be closely adapted to all teeth surfaces. The presently described processes utilize the concept of shrinkage in a positive manner. According to the disclosed methods, an orthodontic appliance or other device intended for use in the mouth, such as a night guard, is made by a process which includes scanning a patient's dental arch or a mould of a dental arch such as a traditional plaster mould, to form a digital dental arch file corresponding to the size and position of the patient's dental arch, the digital dental arch file containing data corresponding to a plurality of dimensions corresponding to portions of the patient's dental arch; modifying the digital dental arch file to decrease at least one of said dimensions; and utilizing said modified digital dental arch file to form a dental appliance.

According to one disclosed method, the received or obtained initial scans/physical impression of a dental arch, referred to herein as “digital dental arch file”, is processed by analyzing, sculpting, digital treatment planning and finally a percentage shrinkage is applied to at least one dimension corresponding to a portion of the patient's dental arch before 3D printing. The printed mould, hence formed, is smaller in size/shrunk relative to the actual initial scan of a clinical dental arch.

Appliances formed with shrinkage applied to at least one dimension corresponding to apportion of the patient's dental arch prior to 3D printing improves the retention of the appliance on the patient's tooth surfaces and increases the surface area contact between the orthodontic appliance and the tooth surfaces in the patient's oral cavity. Hence, the appliances formed via this method fit more snugly and exert more optimum orthodontic forces for better treatment outcomes.

### BRIEF DESCRIPTION OF THE DRAWINGS

FIG. 1 shows a clinical dental arch.

FIG. 2 illustrates a conventional 3D model of the clinical dental arch shown in FIG. 1.

FIG. 3 shows a computer processor for forming a digital dental arch file and for processing the digital dental arch file to impart the desired shrinkage.

FIG. 4 shows the 3D model resulting from the processing to impart dimensional shrinkage.

FIG. 5 shows the printing of the shrunk scan using a 3D printer.

FIG. 6 shows the improved “shrunken” printed mould 2

FIG. 7 shows the clear orthodontic appliance 3 formed over a shrunken printed mould 2

FIG. 8 shows the clear orthodontic appliance 3 isolated from the shrunken mould 2

FIG. 9 shows the clear orthodontic appliance 3 fitted snugly on the clinical dental arch shown in FIG. 1.

FIG. 10 illustrates a dental arch without shrinkage.

FIG. 11 illustrates a dental arch model formed with shrinkage and an orthodontic appliance (aligner) formed on top of the shrunken model.

FIG. 12 illustrates a screen shot of a processor applying shrinkage.

### DETAILED DESCRIPTION

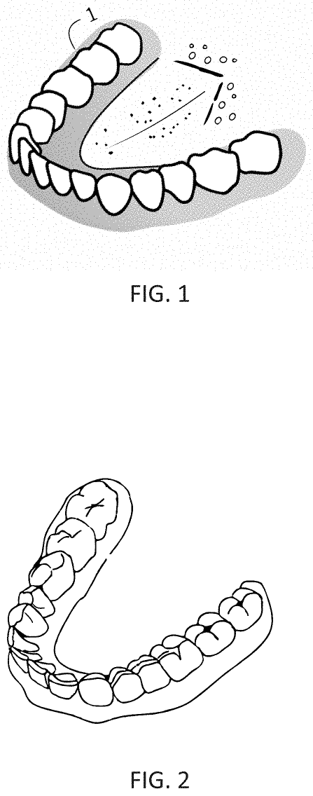

FIG. 1 illustrates a clinical arch 1 with malocclusion (mild crowding) which requires orthodontic treatment for levelling and alignment.

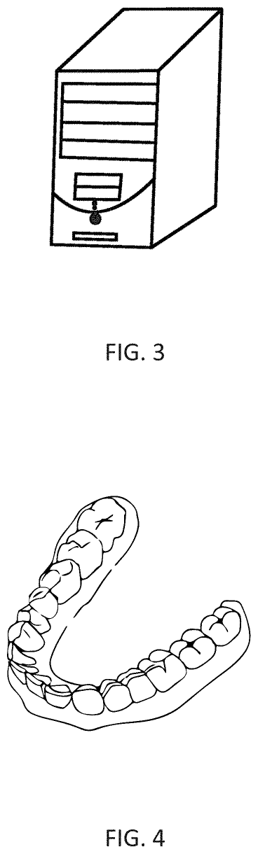

FIG. 2 illustrates the initial intraoral raw scan of the clinical arch 1. An intraoral scan is taken by a dentist or orthodontist over which a functional orthodontic appliance is made. This “scan” is a positive mould which is the product of the 3D printing process.

FIG. 3 illustrates the processing of initial data which is in the form of raw intraoral scan sent from a dentist or an orthodontist. The initial scan is referred to herein as a digital dental arch file. The digital dental arch file contains data corresponding to a plurality of dimensions corresponding to portions of the patient's dental arch. A percentage shrinkage or a predetermined dimensional shrinkage, e.g. 0.15 mm is applied to at least a portion of the initial digital dental arch file before the last stage of processing i.e. 3D printing. The percentage of shrinkage is preferably about 0.5 to about 3 percent. A dimensional shrinkage is preferably about 0.02 mm to about 0.25 mm, and more preferably about 0.10 to about 0.20 mm.

According to one method, shrinkage is applied to reduce the overall dimensions of teeth & surrounding tissues.

According to another method, shrinkage is applied about a central anterior-posterior axis running through the center of the dental arch.

According to a still further method, shrinkage is applied to the portions of the digital dental arch file around the center of each tooth so that the resulting appliance fits more snuggly on each tooth but the centered spacing between each tooth does not change.

FIG. 4 illustrates the shrunken 3D scan. A very slight change in dimensions is done to improve retention of appliance only.

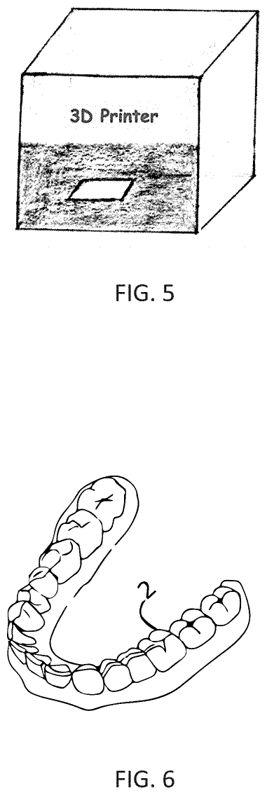

FIG. 5 illustrates the printing of shrunken 3D scan using a 3D printer into physical mould 2 over which orthodontic appliance will be thermoformed.

FIG. 6 illustrates the printed shrunken mould 2. This is a template for fabrication of an orthodontic appliance.

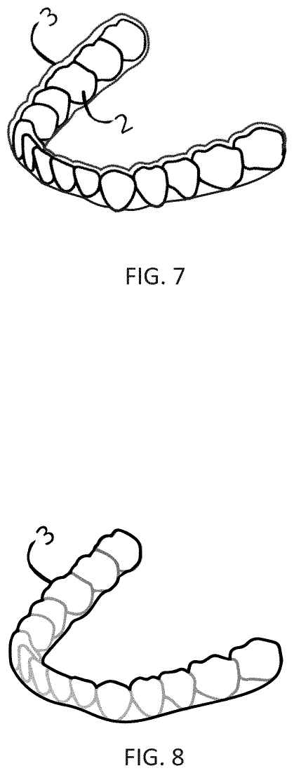

FIG. 7 illustrates the orthodontic appliance 3 thermoformed over the shrunken mould 2.

FIG. 8 illustrates the orthodontic appliance 3 isolated from the shrunken mould 2.

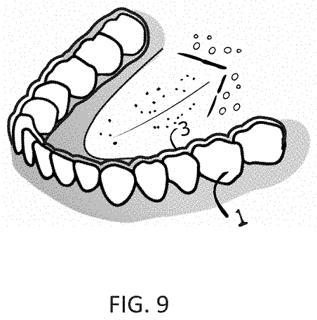

FIG. 9 illustrates orthodontic appliance 3 which was formed over the shrunken mould 2, now placed over the patient's clinical dental arch 1 of relatively larger size. As the size of clinical arch 1 is larger and the appliance 3 is slightly shrunk, the appliance is tightly adapted onto the clinical arch 1.

FIG. 10 illustrates a dental arch without shrinkage.

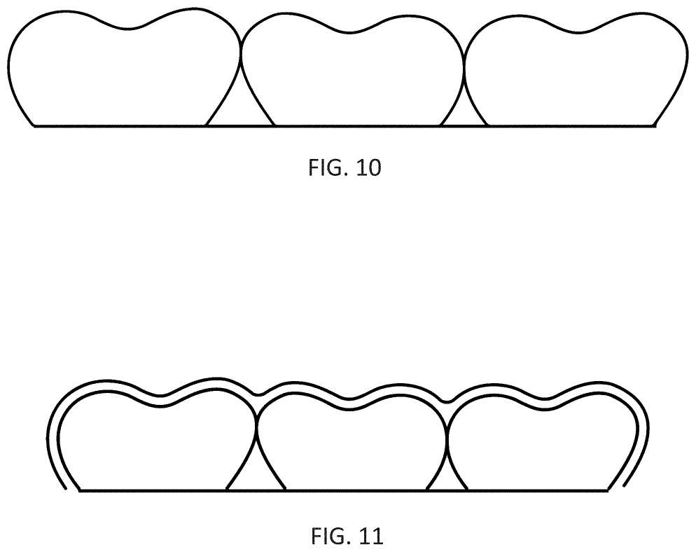

FIG. 11 illustrates a dental arch model formed with shrinkage and an orthodontic appliance (aligner) formed on top of the shrunken model.

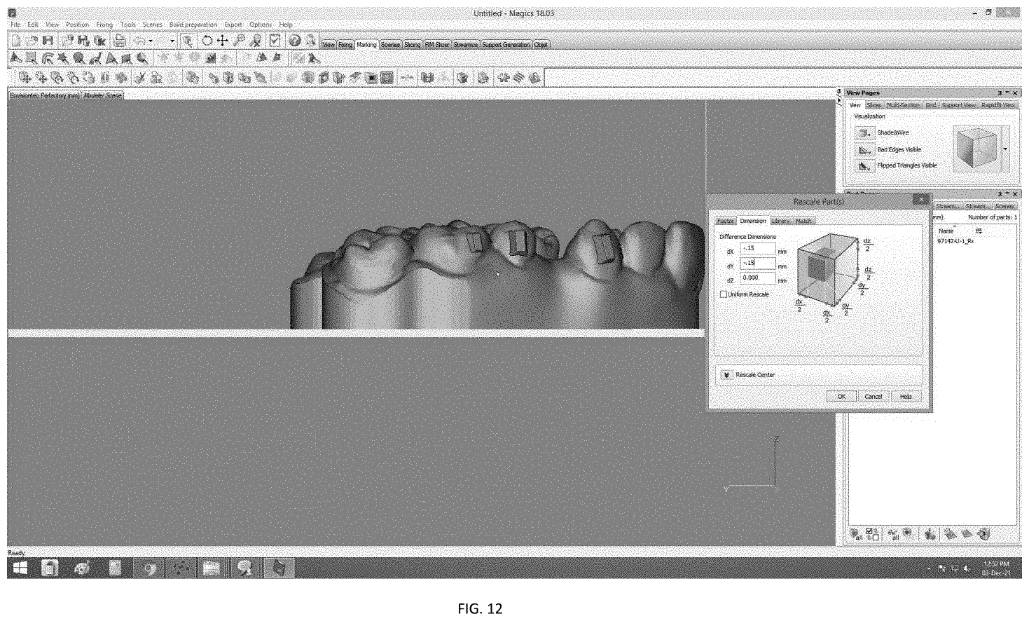

FIG. 12 illustrates a screen shot of a processor applying shrinkage along the x-axis and the y-axis, but not the z-axis, to an entire dental arch. As illustrated by this screenshot, with a computer interface the extent of shrinkage applied can be controlled by the doctor or technician. The person providing the input can determine to which portions of the resulting dental arch the shrinkage will be applied. In this illustrated example, shrinkage is being applied to the entire dental arch along the x-axis and the y-axis, but not along the z-axis. In each instance, 0.15 mm of shrinkage is being applied.

By adding a relatively minor percentage or dimensional amount of shrinkage in initial scan before printing the file into the positive dental mould which will be used for fabrication of an appliance provides the formation of a more retentive (snug fit) appliance having enhanced contact with the patient's teeth. This snug fit appliance is capable of exerting more optimum orthodontic forces (functionally improved) for better treatment outcomes

1. A method of forming an orthodontic appliance comprising the steps of:
scanning a patient's dental arch to form a digital dental arch file corresponding to the size and position of the patient's dental arch, said digital dental arch file containing data corresponding to a plurality of dimensions corresponding to portions of the patient's dental arch;
modifying the digital dental arch file to decrease at least one of said dimensions; and
utilizing said modified digital dental arch file to form a dental appliance.

2. A method of forming an orthodontic appliance according to claim 1 wherein said utilizing step comprises 3D printing.

3. A method of forming an orthodontic appliance according to claim 1 wherein said plurality of dimensions correspond to anterior, posterior, right lateral and left lateral positions of portions of the patient's dental arch.

4. A method of forming an orthodontic appliance according to claim 1 wherein said digital dental arch file comprises data corresponding to the anterior-to-posterior dimension of at least one portion of the patient's dental arch.

5. A method of forming an orthodontic appliance according to claim 1 wherein said modifying step comprises reducing the anterior-to-posterior dimension of at least one portion of the patient's dental arch.

6. A method of forming an orthodontic appliance according to claim 5 wherein said digital dental arch file comprises data corresponding to the right lateral-to-left lateral dimension of at least one portion of the patient's dental arch.

7. A method of forming an orthodontic appliance according to claim 6 wherein said modifying step comprises reducing a lateral dimension of at least one portion of the patient's dental arch.

8. A method of forming an orthodontic appliance according to claim 1 wherein said digital dental arch file comprises data corresponding to the right lateral-to-left lateral dimension of at least one portion of the patient's dental arch.

9. A method of forming an orthodontic appliance according to claim 8 wherein said modifying step comprises reducing a lateral dimension of at least one portion of the patient's dental arch.

10. A method of forming an orthodontic appliance comprising the steps of:
forming a mould of a patient's dental arch;
digitally scanning said mould to form a digital dental arch file corresponding to the size and position of at least a portion of said mould, said digital dental arch file containing data corresponding to a plurality of dimensions corresponding to portions of the mould;
modifying the digital dental arch file to decrease at least one of said dimensions; and
utilizing said modified digital dental arch file to form a dental appliance.

11. A method of forming an orthodontic appliance according to claim 10 wherein said utilizing step comprises 3D printing.

12. A method of forming an orthodontic appliance according to claim 10 wherein said plurality of dimensions correspond to anterior, posterior, right lateral and left lateral positions of portions of the patient's dental arch.

13. A method of forming an orthodontic appliance according to claim 10 wherein said digital dental arch file comprises data corresponding to the anterior-to-posterior dimension of at least one portion of the mould.

14. A method of forming an orthodontic appliance according to claim 10 wherein said modifying step comprises reducing the anterior-to-posterior dimension of at least one portion of the mould.

15. A method of forming an orthodontic appliance according to claim 14 wherein said digital dental arch file comprises data corresponding to the right lateral-to-left lateral dimension of at least one portion of the mould.

16. A method of forming an orthodontic appliance according to claim 15 wherein said modifying step comprises reducing a lateral dimension of at least one portion of the mould.

17. A method of forming an orthodontic appliance according to claim 10 wherein said digital dental arch file comprises data corresponding to the right lateral-to-left lateral dimension of at least one portion of the mould.

18. A method of forming an orthodontic appliance according to claim 17 wherein said modifying step comprises reducing a lateral dimension of at least one portion of the mould.
